(19) United States
(12) Patent Application Publication
(10) Pub. No.: US 2025/0030352 A1
(43) Pub. Date: Jan. 23, 2025

(54) VOLTAGE BOOST MODULE FOR A POWER CONVERTER

(71) Applicant: Eaton Intelligent Power Limited, Dublin (IE)

(72) Inventors: Hua Qiang Li, Menomonee Falls, WI (US); Yaojin Mo, Guangdong Province (CN); Zhe Zhang, Menomonee Falls, WI (US); Jimmy Qi, Menomonee Falls, WI (US)

(21) Appl. No.: 18/224,829

(22) Filed: Jul. 21, 2023

(51) Int. Cl. H02M 5/458; H02M 1/44

(52) U.S. Cl. CPC H02M 5/458; H02M 1/44

(57) ABSTRACT

In one aspect, a power converter includes: an energy storage apparatus; an inverter electrically coupled to the energy storage apparatus; and a voltage boost system configured to: determine a modulation index based on a DC voltage of the energy storage apparatus and a target output voltage of the inverter; and determine whether the target output voltage is in a voltage boost region based on the modulation index; if the target output voltage is in the voltage boost region: determine an adjustment value based on the modulation index; and adjust one or more of the target output voltage and an associated output voltage phase angle based on the adjustment value.

### TECHNICAL FIELD

This disclosure relates to a voltage boost module for a power converter.

### BACKGROUND

An electrical apparatus, such as a variable speed drive, an adjustable speed drive, or an uninterruptable power supply, may be connected to an alternating current (AC) high-power electrical distribution system, such as a power grid. The electrical apparatus drives, powers, and/or controls a machine, or a non-machine type of load. The electrical apparatus includes an electrical network that converts AC power to direct-current (DC) power and may also convert DC power to AC power.

### SUMMARY

In one aspect, a power converter includes: an energy storage apparatus; an inverter electrically coupled to the energy storage apparatus; and a voltage boost system configured to: determine a modulation index based on a DC voltage of the energy storage apparatus and a target output voltage of the inverter; and determine whether the target output voltage is in a voltage boost region based on the modulation index; if the target output voltage is in the voltage boost region: determine an adjustment value based on the modulation index; and adjust one or more of the target output voltage and an associated output voltage phase angle based on the adjustment value.

Implementations may include one or more of the following features.

The voltage boost system may be configured to: determine an inverter gate command based on the target output voltage and the associated target output phase angle; and provide the inverter gate command to the inverter.

In some implementations, if the target output voltage is in the voltage boost region, the voltage boost system is configured to determine whether the target output voltage is in one of a first voltage boost region and a second voltage boost region. Moreover, in some implementations, if the target output voltage is in the first voltage boost region, the voltage boost system is configured to adjust the target output voltage based on the adjustment value; and if the target output voltage is in the second voltage boost region, the voltage boost system is configured to adjust the associated target output voltage phase angle based on a second adjustment value.

The adjustment value may be an adjustment angle that is a function of the modulation index. The voltage boost system may be configured to determine the adjustment value from a pre-determined look-up table.

The power converter also may include a rectifier electrically connected to the energy storage apparatus. The power converter also may include a filter system electrically connected to the energy storage, the filter system configured to electrically connect to an alternating current (AC) power source. In these implementations, the voltage boost system may be configured to: determine an inverter gate command based on the target output voltage and the associated target output phase angle; and provide the inverter gate command to the inverter to control the inverter to produce the target output voltage at the target output voltage phase angle, and the peak voltage of the target output voltage is the same or greater than the peak voltage of the AC power source.

In another aspect, a control system for an inverter includes: a boost module configured to: access a target output voltage and target output phase angle of the inverter; determine a modulation index based on a DC bus voltage of an inverter and the target output voltage of the inverter; determine whether the target output voltage is in a linear region of the inverter or a voltage boost region of the inverter based on the modulation index; if the target output voltage is in the voltage boost region: determine an adjustment value based on the modulation index; and adjust one or more of the target output voltage and the target output voltage phase angle based on the adjustment value; and if the target output voltage is in the linear region of the inverter, the boost module is configured to not adjust the target output voltage and the target output phase angle. The control system also includes a command module configured to: determine an inverter command based on the target output voltage and the target output voltage phase angle; and control the inverter based on the inverter command.

In another aspect, a method includes: determining a modulation index based on a measured DC bus voltage of an inverter and a target output voltage of the inverter; determining whether a target output voltage of an inverter is in a space vector pulse width modulation (SVPWM) linear region based on the modulation index; if the target output voltage of the inverter is outside of the linear region: determining an angle adjustment value based on the modulation index; and adjusting one of the target output voltage and a target output phase angle based on the angle adjustment value; and if the target output voltage of the inverter is in the linear region, not adjusting the target output voltage or the target output phase angle.

Implementations may include one or more of the following features.

Determining the angle adjustment value based on the modulation index may include determining the angle adjustment value from a lookup table that relates the angle adjustment value to the modulation index. Generating the lookup table may include varying the angle adjustment value for a plurality of different values of the target output phase angle.

The method also may include: determining an inverter command based on the target output voltage and the target output voltage phase angle; and controlling the inverter based on the inverter command. Controlling the inverter based on the inverter command may cause the inverter to output the target output voltage, and the target output voltage has a peak voltage that is the same as or greater than a peak voltage of an AC input.

Implementations of any of the techniques described herein may include an apparatus, a device, a system, a control system, machine-executable instructions, and/or a method. The details of one or more implementations are set forth in the accompanying drawings and the description below. Other features will be apparent from the description and drawings, and from the claims.

### DRAWING DESCRIPTION

FIG. 1 is a block diagram of an example of a system that includes a power converter.

FIG. 2 is a schematic of an example of a system that includes a power converter.

FIG. 3 is a block diagram of an example of a control scheme.

FIG. 4 relates to an example of an operating hexagon of an inverter.

FIG. 5 is a block diagram of an example of a voltage boost module.

FIG. 6A is a flow chart of an example of a voltage boosting process that may be implemented by voltage boost module of FIG. 5.

FIG. 6B relates to another example of an operating hexagon of an inverter.

FIG. 7 shows a flow chart of a process 700A, which is an example of a process for generating a lookup table, and a flow chart of a process 700B, which is an example of a process for obtaining a value of an adjustment parameter from the lookup table.

FIG. 8 is a flowchart of an example of a process for generating an inverter gate command.

FIGS. 9-12 show examples of simulated data.

### DETAILED DESCRIPTION

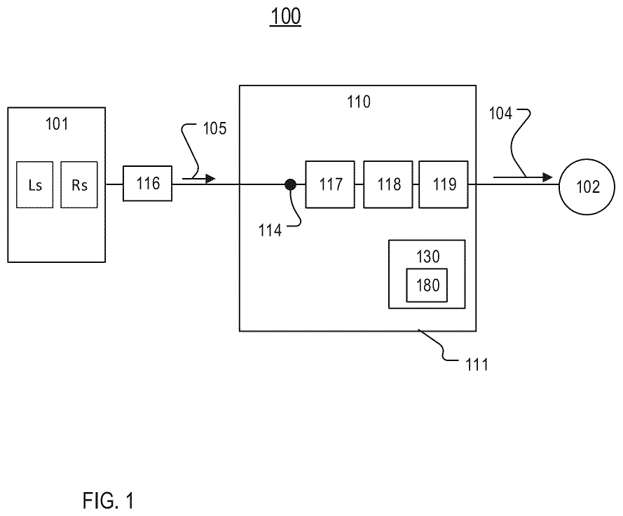

Referring to FIG. 1, a block diagram of a system 100 is shown. The system 100 includes an electrical apparatus or power converter 110 that is electrically connected to an alternating current (AC) electrical power distribution network 101 and a load 102. The electrical apparatus 110 generates a driver signal 104 for the load 102 based on electrical power 105 from the distribution network 101. For example, the electrical apparatus 110 may be a variable speed drive (VSD) or an adjustable speed drive (ASD) and the load 102 may be a machine-type load such as, for example, an induction machine, an induction motor, or a synchronous permanent magnet machine that operates at a speed and torque that is determined by the driver signal 104. In some implementations, the electrical apparatus 110 is an uninterruptable power supply (UPS) that provides electrical power to a non-machine type of load 102, such as a lighting system.

The electrical apparatus 110 includes a rectifier 117, a direct current (DC) link 118, and an inverter 119. The rectifier 117 includes electronic switches (for example, diodes) that are arranged to convert AC current into DC current that is stored in the DC link 118. The inverter 119 includes controllable switches (for example, transistors) that are controlled to modulate the energy stored in the DC link 118 based on a space vector pulse width modulation (SVPWM) technique into the driver signal 104.

A filter system 116 is connected in series with the rectifier 117 between an input node 114 of the apparatus 110 and the distribution network 101. During operation of the electrical apparatus 110, a voltage drop may be present across the filter system 116. As the demands of the load 102 increase, the voltage drop may become significant, reducing the voltage of the driver signal 104 and thus reducing the voltage available for the load 102. As a result, the operation of the load 102 and/or systems that are driven by the load 102 and/or rely on the operation of the load 102 may be compromised.

Moreover, although controlling the inverter 119 using an SVPWM technique results in the voltage of the driver signal 104 being about 15% higher than a driver signal produced by controlling the inverter 119 with sinusoidal PWM, SVPWM also may face challenges in some circumstances. For example, as the demands of the load 102 increase, the voltage drop across the filter system 116 and the electrical apparatus 110 also increases, decreasing the voltage that is available for the load 102. Additionally, even if the filter system 116 is removed, when the load 102 is operated in a manner that increases the current drawn (for example, operating the load 102 beyond one or more of its rated parameters), traditional SVPWM cannot create enough output voltage to sustain the operation of the load 102.

On the other hand, and as discussed in more detail below, the control system 130 implements a voltage boost module 180 that provides dynamic voltage compensation that allows more effective use of the inverter 119 and improves the performance of SVPWM in an efficient manner. The voltage boost module 180 is a signal processing based approach that does not involve additional hardware and can be used to retrofit existing systems.

Moreover, the voltage boost module 180 is computationally efficient. The inverter 119 has a linear operating region and a non-linear operating region. Outside of the linear operating region, the output voltage waveform of the inverter 119 may be distorted and the magnitude of the output voltage waveform is less than a reference or target voltage, and the voltage available to the load 102 may be reduced. To address this challenge and to allow the inverter 119 produce sufficient voltage over its entire operating range, the control system 130 includes the voltage boost module 180. The voltage boost module 180 is computationally efficient because it uses one variable (an adjustment value (a), discussed further below) to account for all conditions in the non-linear region. The voltage boost module 180 yields a unified solution which efficiently transitions from linear region operation of the inverter 119 to non-linear region operation of the inverter 219 and then to six-step operation.

The electrical power distribution network 101 may be, for example, a multi-phase electrical power grid that provides electricity to industrial, commercial and/or residential customers. The AC electrical power distribution network 101 distributes AC electrical power that has a fundamental frequency of, for example, 50 or 60 Hertz (Hz). The distribution network 101 may have an operating voltage of, for example, up to 690V. The network 101 may include, for example, one or more transmission lines, distribution lines, power distribution or substation transformers, electrical cables, and/or any other mechanism for transmitting electricity.

The electrical apparatus 110 is enclosed in a housing or enclosure 111. The housing 111 is a three-dimensional body made of a solid and rugged material that protects the electrical apparatus 110. The input node 114 is accessible from an exterior of the housing 111 such that the electrical apparatus 110 may be connected to the distribution network 101. The electrical apparatus 110 also includes an output port (not shown) that is accessible from the exterior of the housing 111. The load 102 connects to the electrical apparatus 110 at the output port.

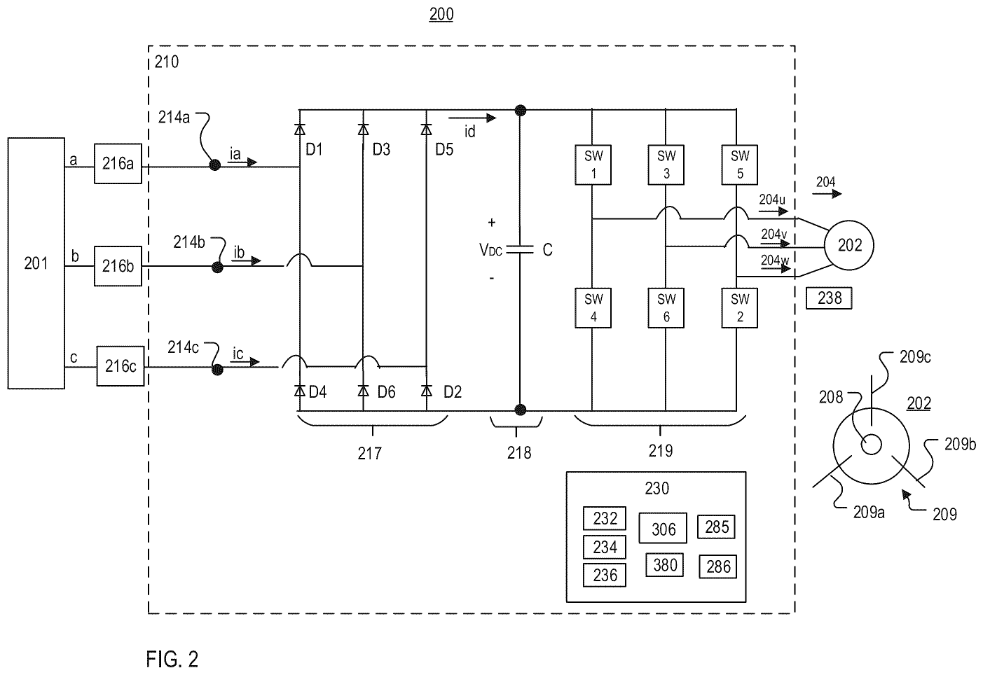

FIG. 2 is a schematic of a system 200. The system 200 includes an electrical apparatus or power converter 210 that is connected to a three-phase AC electrical power distribution network 201 and a load 202. The system 200 also includes an inverter 219 that provides a three-phase driver signal 204 to the load 202, and a control system 230 that controls the inverter 219 to generate the driver signal 204 based on a control scheme 306. The control scheme 306 is based on a SVPWM technique and includes a voltage boost module 380 that provides dynamic voltage compensation when the inverter 219 is operated outside of its linear operating region (for example, when the voltage demand of the load 202 increases).

An overview of the system 200 is provided prior to discussing the control scheme 306 and the voltage boost module 380 in more detail.

In the example of FIG. 2, the load 202 is a three-phase motor 202, such as, for example, an induction motor or a permanent magnet synchronous machine. The motor 202 includes a stator 209, which is spatially fixed, and a rotor 208, which rotates relative to the stator 209 when the driver signal 204 is applied. The stator 209 includes one electrical winding per phase: 209a, 209b, and 209c. Loads other than a motor may be used in the system 200.

The electrical power distribution network 201 distributes AC electrical power that has a fundamental frequency of, for example, 50 or 60 Hertz (Hz). The distribution network 201 may have an operating voltage of up to 690V. The distribution network 201 may include, for example, one or more transmission lines, distribution lines, electrical cables, and/or any other mechanism for transmitting electricity. The distribution network 201 includes three phases, which are referred to as a, b, and c.

The electrical apparatus 210 includes input nodes 214a, 214b, 214c, each of which is electrically coupled to a respective one of the three phases a, b, c of the distribution network 201 through a respective filter system 216a, 216b, 216c. Each filter system 216a, 216b, 216c may be an inductor.

The electrical apparatus 210 includes a rectifier 217, a DC link 218, and the inverter 219. The rectifier 217 is a three-phase six-pulse bridge that includes six electronic switches. In the example of FIG. 2, the six electronic switches are diodes D1-D6. Each diode D1-D6 includes a cathode and an anode and is associated with a forward bias voltage. Each diode D1-D6 allows current to flow in the forward direction (from the anode to the cathode) when voltage of the anode is greater than the voltage of the cathode by at least the bias voltage. When the voltage difference between the anode and the cathode is less than the forward bias voltage, the diode does not conduct current in the forward direction.

The input node 214a is electrically connected to the anode of the diode D1 and the cathode of the diode D4. The input node 214b is electrically connected to the anode of the diode D3 and the cathode of the diode D6. The input node 214c is electrically connected to the anode of the diode D5 and the cathode of the diode D2. The diodes D1-D6 rectify the input currents ia, ib, ic into a DC current id.

The diodes D1-D6 are also electrically connected to the DC link 218. The cathode of each diode D1, D3, D5 is electrically connected to the DC link 218, and the anode of each diode D2, D4, D6 is electrically connected to the DC link 218. The DC link 218 includes a capacitor network C. The rectified current id flows into the capacitor network C and is stored. The capacitor network C includes one or more capacitors that store electrical energy when the rectified current id flows from the rectifier 217 and discharge the stored electrical energy when the rectified current id does not flow from the rectifier 217.

The inverter 219 converts the DC power stored in the capacitor network C into a three-phase AC driver signal 204 that is provided to the load 202. The inverter 219 includes a network of electronic switches SW1-SW6 that are controlled by the control system 230 to generate the driver signal 204. Each of the switches SW1-SW6 may be, for example, a power transistor. The three-phase driver signal 204 has phase components 204u, 204v, 204w, each of which is provided to one of the three-phases of the load 202.

The system 200 also includes a sensor system 238 that measures and/or estimates properties or parameters of the driver signal 204 and/or the motor 202. For example, the sensor system 238 may include current sensors that measure the amount of current drawn in each phase of the motor 202 and/or voltage sensors that measure the voltage of each phase component 204u, 204v, 204w of the driver signal 204. The sensor system 238 also may include sensors that measure the angular position of the rotor 208 of the motor 202 and/or the angular velocity of the rotor 208. In some implementations, the control system 230 uses data from the sensor system 238 (other than directly measured position data) to estimate the angular position and/or angular velocity of the rotor 208 based on a sensorless technique.

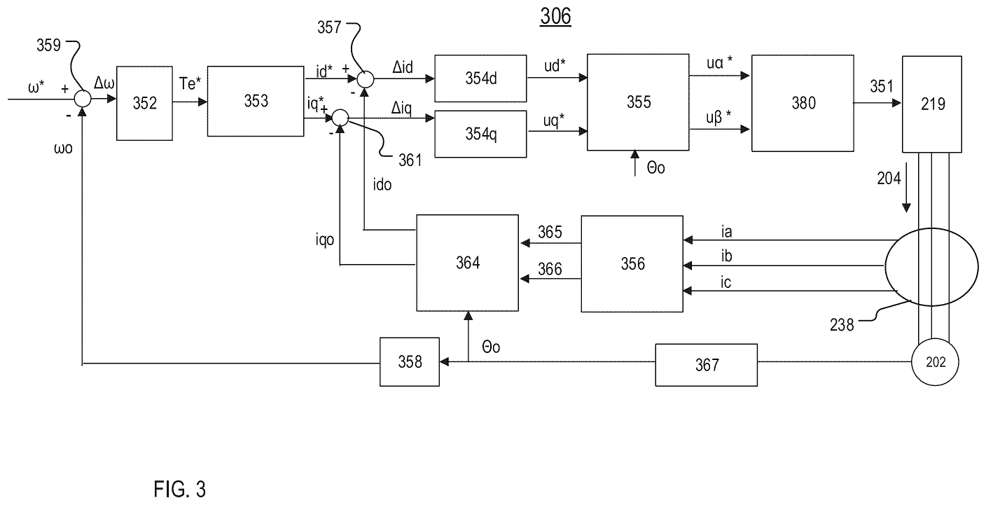

The control system 230 controls the switching pattern of the switches SW1-SW6 to generate the driver signal 204 with particular characteristics (for example, amplitude, frequency, and/or phase). The control system 230 implements a SVPWM control scheme 306 that includes the voltage boost module 380, both of which are discussed with respect to FIG. 3.

The control system 230 includes an electronic processing module 232, an electronic storage 234, and an input/output (I/O) interface 236. The electronic processing module 232 includes one or more electronic processors. The electronic processors of the module 232 may be any type of electronic processor and may or may not include a general purpose central processing unit (CPU), a graphics processing unit (GPU), a microcontroller, a field-programmable gate array (FPGA), Complex Programmable Logic Device (CPLD), and/or an application-specific integrated circuit (ASIC).

The electronic storage 234 may be any type of electronic memory that is capable of storing data and instructions in the form of computer programs or software, and the electronic storage 234 may include volatile and/or non-volatile components. The electronic storage 234 and the processing module 232 are coupled such that the processing module 232 is able to access or read data from and write data to the electronic storage 234. The electronic storage 234 stores instructions that, when executed, cause the electronic processing module 232 to analyze data and/or retrieve information. The electronic storage 234 also may store information about the system 200. For example, the electronic storage 234 may store information about the motor 202 or the inverter 219.

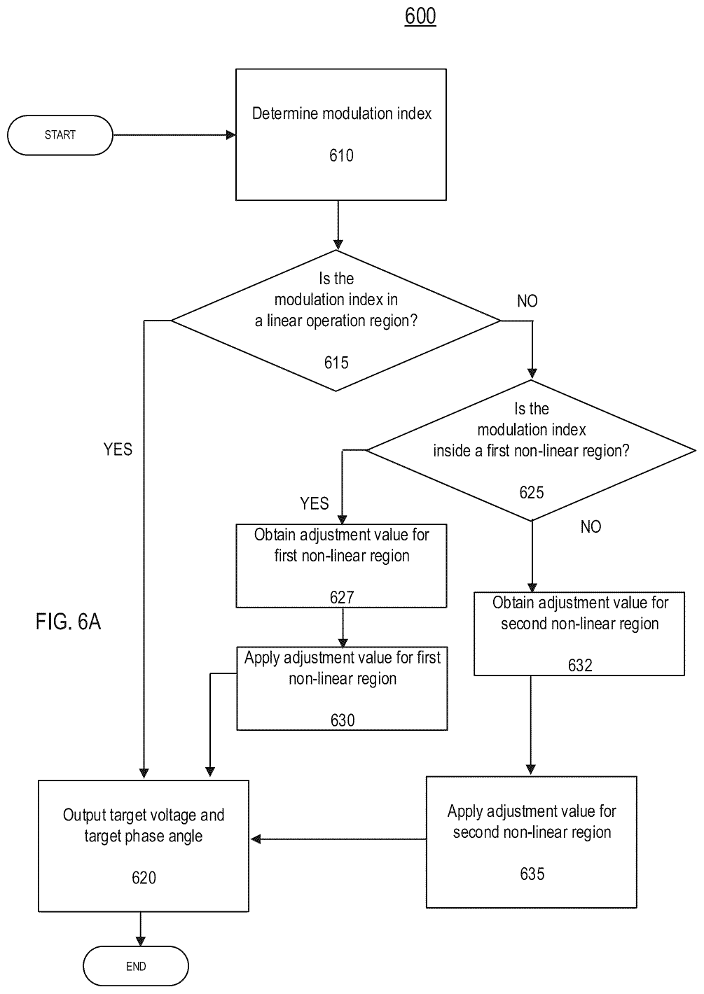

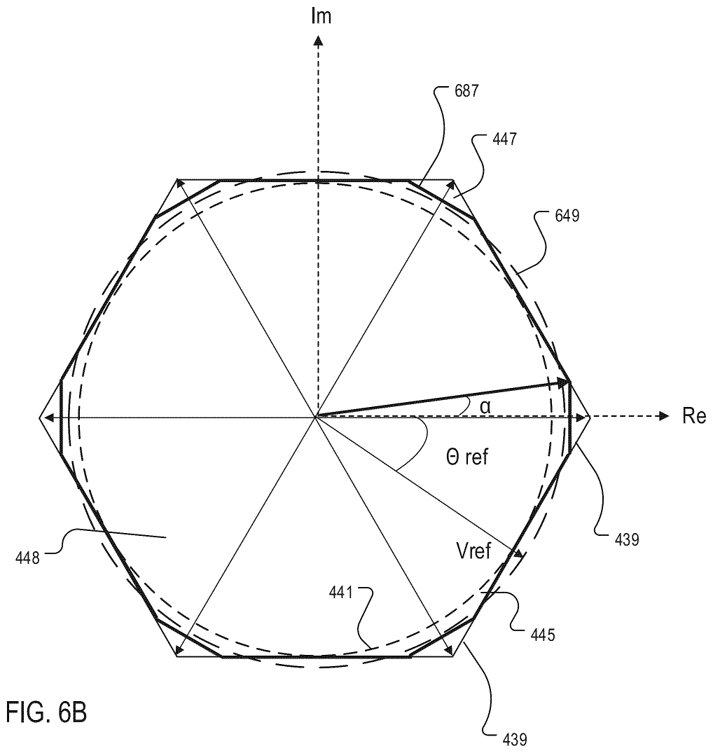

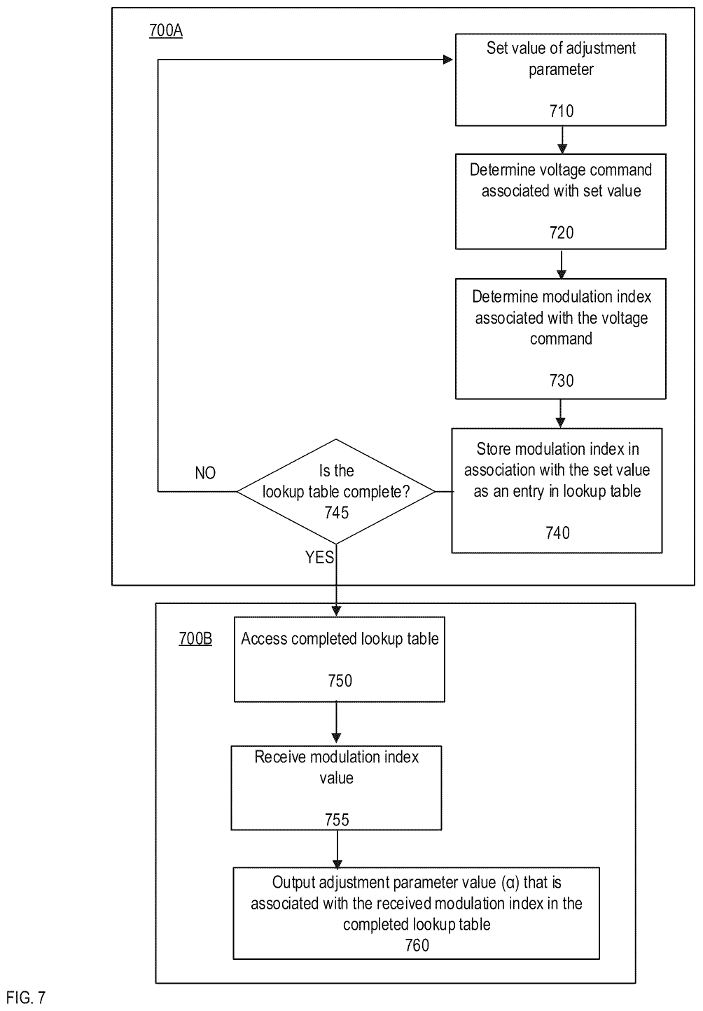

Additionally, the electronic storage 234 may store executable instructions that implement the control scheme 306 and the voltage boost module 380. The electronic storage 234 also may store data and/or information that is used in the control scheme 306 and/or the voltage boost module 380. For example, the electronic storage 234 may store threshold values and/or boundary values associated with operation modes of the inverter 219. The electronic storage 234 also stores lookup tables 285 and 286, which are discussed in more detail with respect to FIGS. 6A, 6B, and 7. The lookup tables 285 and 286 are used in the control scheme 306 and/or the voltage boost module 380.

The I/O interface 236 may be any interface that allows a human operator and/or an autonomous process to interact with the control system 230. The I/O interface 236 may include, for example, a display (such as a liquid crystal display (LCD)), a keyboard, audio input and/or output (such as speakers and/or a microphone), visual output (such as lights, light emitting diodes (LED)) that are in addition to or instead of the display, serial or parallel port, a Universal Serial Bus (USB) connection, and/or any type of network interface, such as, for example, Ethernet. The I/O interface 236 also may allow communication without physical contact through, for example, an IEEE 802.11, Bluetooth, or a near-field communication (NFC) connection. The control system 230 may be, for example, operated, configured, modified, or updated through the I/O interface 236.

The I/O interface 236 also may allow the control system 230 to communicate with components in the system 200 and with systems external to and remote from the system 200. For example, the I/O interface 236 may control a switch or a switching network (not shown) or a breaker within the system 200 that allows the electrical apparatus 210 to be disconnected from the distribution network 201. In another example, the I/O interface 236 may include a communications interface that allows communication between the control system 230 and a remote station (not shown), or between the control system 230 and a separate monitoring apparatus. The remote station or the monitoring apparatus may be any type of station through which an operator is able to communicate with the control system 230 without making physical contact with the control system 230. For example, the remote station may be a computer-based work station, a smart phone, tablet, or a laptop computer that connects to the control system 230 via a services protocol, or a remote control that connects to the control system 230 via a radio-frequency signal.

FIG. 3 is a block diagram of the control scheme 306. The control scheme 306 includes the voltage boost module 380, which generates an inverter gate command 351 to control the switches S1 to S6 of the inverter 219. The inverter 219 generates the three-phase driver signal 204 in response to being controlled by the inverter gate command 351.

The control scheme 306 includes a comparator 359 that compares a target angular velocity (ω*) of the motor 202 to an observed angular velocity (ω) of the rotor 208 and provides the difference (Δω) to a speed controller 352. The observed angular velocity (ω) is determined by providing a measured or estimated angular position (θo) of the rotor 208 to a derivative block 358. The observed angular position (θo) of the rotor 208 is output from an angular position block 367, which determines the observed angular position (θo) from a position sensor in the sensor system 238 or by employing a sensorless angular position estimation technique. The derivative block 358 determines the observed angular velocity (wo) by calculating the rate of change in the angular position (θo) over the time period. The sensor system 238 also measures the current drawn by each phase (each stator winding 209a, 209b, 209c) of the motor 202. The measured currents are ia, ib, and ic. The measured currents ia, ib, ic are provided to a modulation block 356 that implements the Clarke transformation to transform the 3-phase currents (ia, ib, ic) into two orthogonal current components: a component iα along the α axis and a component iβ along the β axis (which is orthogonal to the α axis). The Clark transformation projects a three-phase quantity (such as the current flowing in the windings 209a, 209b, 209c of the stator 209 or the voltage applied to the windings 209a, 209b, 209c of the stator 209) onto a two-dimensional stationary coordinate system defined by the α axis and the β axis. The Clark transformation is shown in Equation (1):

$${i}_{α β} = \frac{2}{3} [ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}{i}_{a} \\ {i}_{b} \\ {i}_{c}\end{matrix} ] , \qquad Equation ( l )$$

where ia, ib, ic are the instantaneous currents in the stator windings 209a, 209b, 209c, and i_{αβ} is a vector that includes a component along the α axis (365) and a component along the β axis (366). The vectors 365 and 366 are provided to a modulation block 364 that implements the Park transformation. The Park transformation rotates the stationary α, β axes at a frequency ω. The Park transformation is shown in Equation (2):

$${i}_{αβ} = \frac{2}{3} [ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}{i}_{a} \\ {i}_{b} \\ {i}_{c}\end{matrix} ] , \qquad Equation ( 1 )$$

$${i}_{dq} = [ \begin{matrix}cos ( θ ) & sin ( θ ) \\ - sin ( θ ) & cos ( θ )\end{matrix} ] [ \begin{matrix}{i}_{α} \\ {i}_{β}\end{matrix} ] , \qquad Equation ( 2 )$$

where i_{dq} is a vector that includes a component along the d axis (ido, or the observed d-axis current) and a component along the q axis (iqo, or the observed q-axis current), and θ is the observed angular position (θo) of the rotor 208 of the motor 202.

The speed controller 352 generates a torque command Te*, which is provided to a current command generator block 353. The current command generator block 353 generates a d-axis current command id* and a q-axis current command iq*. The d-axis current command id* is compared to the observed d-axis current (ido) at a comparator 357 to determine a difference (Δid) between id* and ido*, and the difference (Δid) is provided to a d-axis current controller 354d. The q-axis current command iq* is compared to the observed q-axis current (iqo) at a comparator 361 to determine a difference (Δiq) between iq* and iqo, and the difference (Δiq) is provided to a q-axis current controller 354q.

The d-axis current controller 354d is a proportional-integral (PI) controller with a pre-determined gain constant Kd. The q-axis current controller 354q is a PI controller with a pre-determined gain constant Kq. The d-axis current controller 354d determines a d-axis voltage command ud* that minimizes the d-axis current error (Δi_{d}). The q-axis current controller 354q determines a q-axis voltage command uq* that minimizes the q-axis current error (Δi_{q}).

The d-axis voltage command ud* and the q-axis voltage command uq* are provided to a modulation block 355 that implements the inverse Park transformation. The inverse Park transformation projects the d-axis and q-axis voltage commands (ud*, uq*) onto the stationary α, β reference frame. The outputs of the modulation block 355 are uα* and uβ*, which are the components of the voltage to be applied to the stator 209 in the stationary α, β reference frame.

The voltage commands uα* and uβ* are provided to the voltage boost module 380. The voltage boost module 380 implements an SVPWM-based overmodulation control to generate the inverter gate command 351 based on the voltage commands uα* and uβ*.

The inverter 219 includes the controllable switches S1 to S6, each of which are controllable to be in an ON state or an OFF state. For example, each switch S1 and S6 may be turned ON or OFF by controlling the voltage at the gate of the switch. The state of the switches S1 to S6 is controlled and changed over time in a switching pattern defined by the inverter gate command 351. The switches S1, S3, and S5 are the upper switches, and the switches S4, S6, and S2 are the lower switches. There are eight valid switching configurations or state combinations for the switches S1, S3, and S5. The switching states are represented by space vectors U1 to U8. The switching states U1 to U8 for the upper switches S1, S3, S5 are shown in Table 1:

| Space Vector | S1 | S3 | S5 |
|---|---|---|---|
| U1 | 1 | 0 | 0 |
| U2 | 1 | 1 | 0 |
| U3 | 0 | 1 | 0 |
| U4 | 0 | 1 | 1 |
| U5 | 0 | 0 | 1 |
| U6 | 1 | 0 | 1 |
| U7 | 0 | 0 | 0 |
| U8 | 1 | 1 | 1 |

At any given time, the state of each lower switch S4, S6, S2 is opposite the state of the respective upper switch S1, S3, S5 such that there are eight SVPWM switching configurations or combinations for the inverter 219.

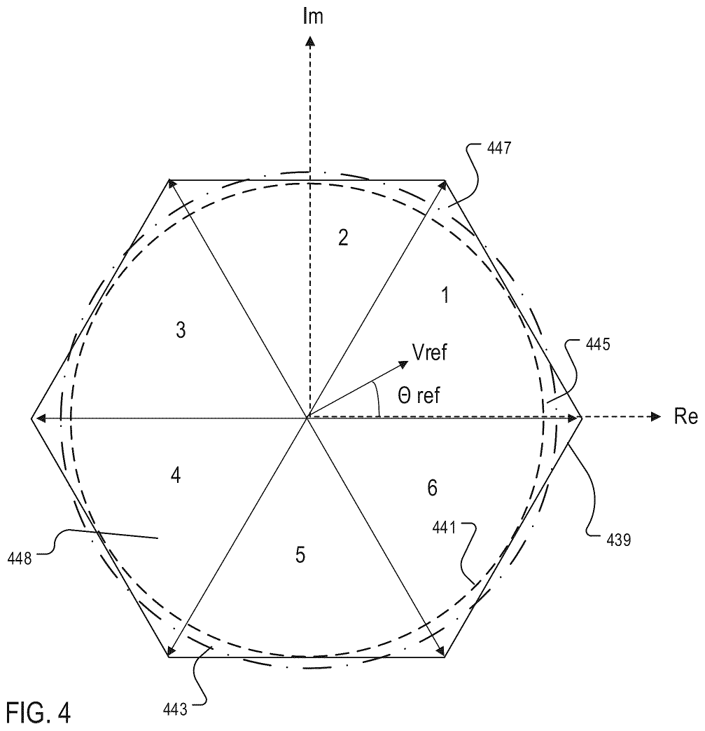

Referring also to FIG. 4, the six non-zero vectors (U1 to U6) define a hexagon 439 and six sectors (1 to 6) in a rectilinear coordinate system (Re, Im). The angle between any two adjacent non-zero vectors (U1 to U6) is 60 degrees) (°. The two zero vectors (U7 and U8) are at the origin. The hexagon 439 represents the limit of operation of the inverter 219. The switching states U1 to U8 are combined to approximate a voltage vector of any magnitude and angle within the hexagon 439. For example, a desired inverter output voltage having a magnitude represented by the vector Vref and a phase angle θref that places the voltage vector in sector 1 is achieved by a switching sequence that utilizes the two adjacent switching states (U1 and U2 in this example) for a specified period of time and a zero vector (U7 or U8) for the rest of the period.

The voltage commands uα* and uβ* input to the voltage boost module 380 define the vector Vref at a phase angle (θref) in the Re, Im coordinate system shown in FIG. 4. The voltage vector (Vref) and the angle (θref) are referred to as the target or reference voltage and angle. The length of the vector Vref is characterized with the modulation index (M), which is determined by Equation (3):

$$M = \frac{Vref}{\frac{2}{π} Vdc} , \qquad Equation ( 3 )$$

where M is the modulation index, Vref is the amplitude of the reference or target voltage (the length of the vector Vref in FIG. 4), and Vdc is the measured voltage across the DC link 218.

FIG. 4 also includes a first circle 441 (dashed line) that is inscribed in the hexagon 439 and a second circle 443 (dash-dot line) that has a larger radius than the first circle 441. The first circle 441 defines the linear operating region 448 of the inverter 219. Reference voltages that have a modulation index (M) less than the radius of the first circle 441 are within the linear operating region 448 of the inverter 219. In the linear operating region 448, the inverter 219 acts as a linear amplifier when controlled with SVPWM. For reference voltages (Vref) having modulating indexes (M) within the circle 441, the output voltage of the inverter 219 may be modeled as a linear function of the gain of the inverter, the voltage of the DC link 218, and the target voltage Vref. The radius of the first circle 441 may, for example, correspond to a modulation index (M) of 0.906. In this example, target voltages associated with a modulation index of less than 0.906 are in the linear operating region 448 of the inverter 219.

Reference voltages that have a modulation index that is greater than the radius of the first circle 441 are not in the linear operating region 448 of the inverter 219. For example, reference voltages having a modulation index (M) in the annulus between the first circle 441 and the second circle 443 or outside of the second circle 443 are outside of the linear operating region 448 of the inverter 219. The portion of the annulus between the first circle 441 and the second circle 443 is a first non-linear region 445 (or a first voltage boost region 445), and the area outside of the second circle 443 that is within the hexagon is a second non-linear region 447 (or a second voltage boost region 447). The radius of the second circle 443 may correspond to a modulation index (M) of 0.951.

A traditional SVPWM technique is not able to command the inverter 219 in a manner that enables the inverter 219 to produce sufficient voltage to meet the reference voltage Vref outside of the linear operating region 448. Outside of the linear operating region 448, the output voltage waveform of the inverter 219 is distorted and the magnitude of the output voltage waveform is less than the reference or target voltage (Vref). To address this challenge and to allow the inverter 219 produce sufficient voltage over its entire operating range, the control system 230 includes the voltage boost module 380.

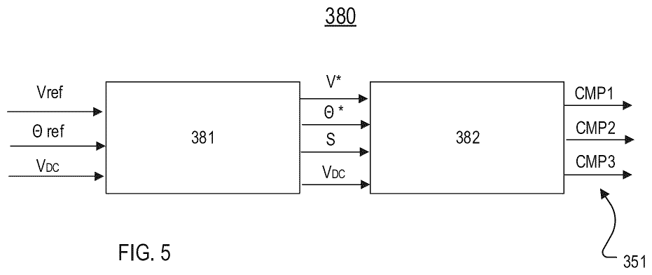

FIG. 5 is a block diagram of the voltage boost module 380. The voltage boost module 380 includes a correction module 381 and a command module 382. The correction module 381 determines a voltage command V* and a phase angle θ* based on the reference or target voltage Vref, the reference or target phase angle θref, and the voltage across the DC link 218 (VDC). The command module 382 determines the inverter gate command 351 based on a SVPWM technique that uses the voltage command V*, the phase angle θ*, S (the SVPWM sector determined by the phase angle θ*), and the voltage of the DC link 218 (VDC) as inputs. The inverter gate command 351 includes components CMP1, CMP2, CMP3, each of which are calculated compare values that define a switching pattern for one phase of the inverter 219.

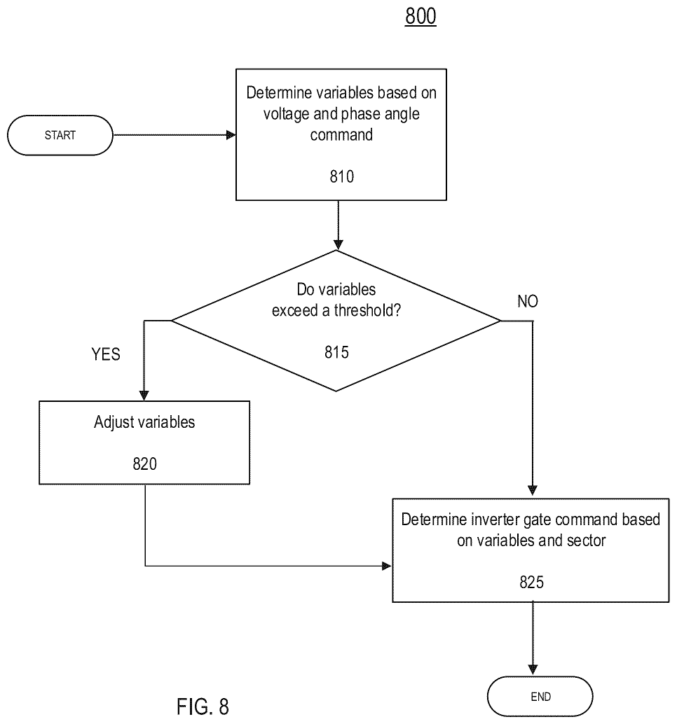

The correction module 381 is discussed in more detail with respect to FIGS. 6A and 6B. The command module 382 is discussed in more detail with respect to FIG. 8.

Referring to FIG. 6A, a flow chart of a process 600 is shown. The process 600 is an example of a voltage boosting process that may be implemented by the correction module 381. The process 600 may be implemented as executable instructions that are stored on the electronic storage 234 and executed by the electronic processing module 232. The process 600 may be implemented as software and may be programmed into a control system in an existing power converter. Moreover, the process 600 may be implemented as a control system or controller that is installed in existing power converter as a software update or as part of a firmware update.

The process 600 begins and the modulation index (M) is determined (610) using Equation (3). To determine the modulation index (M) with Equation (3), the voltage of the DC link 218 (VDC) is a measured value of the voltage across the DC link 218 and Vref is the reference voltage associated with the voltage commands (uα*, uβ*) output from the modulation block 355 (FIG. 3).

The modulation index (M) is compared to a linear operating region boundary to determine whether the inverter 219 can accurately produce the reference voltage (Vref) in the linear operating region 448 using traditional SVPWM (615). If the modulation index (M) associated with the reference voltage (Vref) is equal to or less than the radius of the circle 441, the inverter 219 can produce the reference voltage (Vref) while operating in the linear operating region 448. The process 600 advances to (620), and the reference voltage (Vref) and the reference phase angle (θref) are output from the correction module 381 as the output voltage (V*) an the output phase angle (θ*). In other words, if the modulation index (M) is less than or equal to the linear operating region boundary, no modification or adjustment is made to the reference voltage (Vref) or the reference phase angle (θref).

If the modulation index (M) is determined at (610) is not within the linear operating region 448, the process 600 advances to (625) to determine whether the inverter 219 would operate in the first non-linear region 445 or the second non-linear region 447 to produce the target output voltage. If the modulation index (M) has a value between the radius of the first circle 441 and the radius of the second circle 443, the inverter 219 would operate in the first non-linear region 445 to produce the reference voltage Vref. If the modulation index (M) has a value that is greater than the radius of the second circle 443, the inverter 219 would operate in the second non-linear region 447 to produce the reference voltage Vref.

If the inverter 219 would operate in the first non-linear region 445 or the second non-linear region 447 to produce the reference voltage Vref, an adjustment value (a) is determined based on the modulation index (M). The adjustment value (a) is specific angular value that adjusts the reference voltage (Vref) and/or phase angle (θref) such that the inverter 219 is able to accurately output the reference voltage Vref. FIG. 6B shows a graphical example of an adjustment value (a). In the example of FIG. 6B, the reference voltage (Vref) has a modulation index (M) that is in the first non-linear region 445. The circle 649 (long dash line style) is the ideal trajectory set by the reference voltage Vref. However, the trajectory 649 exceeds the operating hexagon 439 of the inverter 219 at some points. The adjustment value (a) sets an adjusted trajectory 687 (bold line) that achieves the same fundamental voltage as the trajectory 649 and does not exceed the operating hexagon 439 of the inverter 219.

The first lookup table 285 relates the adjustment value (a) and the modulation index (M) in the first non-linear region 445. The second lookup table 286 relates the adjustment value (a) and the modulation index (M) in the second non-linear region 447.

Returning to FIG. 6A, if the inverter 219 would operate in the first non-linear region 445) the adjustment value (α) for the modulation index (M) determined in (610) is obtained from the first lookup table 285 (627). The first lookup table 285 includes an adjustment value (α) for each of a plurality of modulation index values (M) in the first non-linear region 445. An example of the first lookup table is shown in Table 2:

| α (radians) | Modulation Index (M) |
|---|---|
| 0 | 0.95142615 |
| 0.00068569 | 0.95136157 |
| 0.03205707 | 0.95117309 |
| 0.04274276 | 0.95045491 |

The modulation index (M) determined in (610) is provided to the lookup table 285 and the adjustment value (α) that corresponds to that modulation index (M) is returned as an output. If the modulation index (M) determined in (610) is not included in the lookup table 285, the adjustment value (α) is determined by interpolating between adjustment values for other modulation indexes (M) that are included in the lookup table 285. In other implementations, a function or functions may be derived from the values of the adjustment value (α) in the lookup table 285 and used to estimate the adjustment value (α) for other modulation indexes. The development of the lookup table 285 is discussed with respect to FIG. 7.

The obtained value of the adjustment value (α) is applied to the reference voltage (Vref) and reference phase angle (θref) (630). Equations (4) and (5) show the adjustment for the first non-linear region 445:

$$V *= \frac{\frac{\sqrt{3}}{3} {V}_{DC}}{cos ( \frac{π}{6} - α )} , \qquad Equation ( 4 )$$

$$θ *= {θ}_{ref} mod ( \frac{π}{3} ) , \qquad Equation ( 5 )$$

where, in Equation (4), V* is the adjusted voltage command, VDC is the measured voltage across the DC link 218, and a is the adjustment value obtained in (627). In Equation (5), θ* is the adjusted phase angle, θref is the reference phase angle, and mod is the modulo operation. The adjusted voltage command (V*) and the adjusted phase angle (θ*) determined in Equations (4) and (5) are the outputs of the correction module 381 (620).

Returning to (625), if the inverter 219 would operate in the second non-linear region 447 to produce the reference voltage (Vref), the adjustment value (α) is obtained from the second lookup table 286 (632). The second lookup table 286 includes an adjustment value (α) for each of a plurality of modulation index values (M) in the second non-linear region 447. An example of the second lookup table 286 is shown in Table 3, with the adjustment value (α) in the left column and corresponding values of modulation index (MI) in the right column:

| α (rad) | MI |
|---|---|
| 0 | 0.951473244 |
| 0.010685689 | 0.953426394 |
| 0.021371379 | 0.955377105 |
| 0.032057068 | 0.957322935 |
| 0.042742757 | 0.959261446 |
| 0.053428446 | 0.961190198 |
| 0.064114136 | 0.963106756 |
| 0.074799825 | 0.965008682 |

To obtain the adjustment value (α), the modulation index (M) determined in (610) is provided to the second lookup table 286 and the adjustment value (α) that corresponds to that modulation index (M) is returned as an output. To provide a more specific example based on Table 3, if the modulation index (M) determined in (610) is equal to 0.953426394, the correction module 381 accesses the second lookup table 286 and returns a value of 0.010685689 as the adjustment value (α).

The adjustment value (α) is used to determine the adjusted voltage command (V*) and the phase angle (θ*) (635). The voltage command adjustment for the second non-linear region 447 is shown in Equation (6):

$$V *= \frac{2}{3} {V}_{DC} , \qquad Equation ( 6 )$$

where V* is the adjusted voltage command and VDC is the voltage across the DC link 218. The adjusted reference phase angle (θ*) is determined from one of Equations (7), (8), (9), depending on the value of the adjustment value (α) determined in (632).

$$θ *= 0 , \qquad Equation ( 7 )$$

$$θ *= \frac{π}{3} , \qquad Equation ( 8 )$$

$$θ *= h [ ( {θ}_{ref} mod ( \frac{π}{3} ) ) - α ] , \qquad Equation ( 9 )$$

$$with$$

$$h = \frac{1}{1 - ( \frac{6 α}{π} )} . \qquad Equation ( 10 )$$

Equation (7) applies when the value of (α) is greater than or equal to

$${θ}_{ref} mod \frac{π}{3} .$$

Equation (8) applies when the quantity

$$( {θ}_{ref} mod \frac{π}{3} )$$

is greater than or equal to the quantity

$$( \frac{π}{3} - α ) .$$

Equation (9) applies otherwise. The adjusted voltage command (V*) and the phase angle (θ*) are the outputs of the correction module 381 (620).

In addition to outputting the voltage command (V*) and the phase angle (θ*), the correction module 381 also may output the SVPWM sector(S) associated with the phase angle (θ*). The sectors(S) are shown in FIG. 4 and are determined as follows: sector 1: θ*=0° to 60°; sector 2, 60°<θ*≤120°; sector 3:120°<θ*≤180°; sector 4:180°<θ*≤210°; sector 5: 210°<θ*≤270°; and sector 6:270°<θ*≤360°.

FIG. 7 is a flow chart of a process 700A for creating a lookup table that relates the adjustment parameter (α) with the modulation index (M). FIG. 7 also includes a flow chart of a process 700B for obtaining a value of the adjustment parameter using the lookup table generated by the process 700A. The processes 700A and 700B are performed by the control system 230. The process 700A may be performed before the process 600 to generate the lookup tables 285 and 286 before the process 600 begins. Other implementations are possible. For example, the process 700A may be performed with the process 600. For example, the process 700A may be invoked at (627) and/or at (632) to obtain the value of the control parameter (α) without necessarily creating the lookup tables 285 and/or 286 prior to initiating the process 600. The process 700B is performed after the lookup table is generated by the process 700A.

The voltage command (V*) is expressed as:

$$V * \frac{1}{π} {\int }_{0}^{2 π} f ( θ ) cos ( θ ) d θ , \qquad Equation ( 11 )$$

which can also be expressed as shown in Equation (12):

$$V * \frac{4}{π} {\int }_{0}^{α} f 1 ( θ ) cos ( θ ) d θ + {\int }_{α}^{\frac{π}{3} - α} f 2 ( θ ) cos ( θ ) d θ + {\int }_{\frac{π}{3} - α}^{\frac{π}{3} + α} f 3 ( θ ) cos ( θ ) d θ + {\int }_{\frac{π}{3} + α}^{α} f 4 ( θ ) cos ( θ ) d θ . \qquad Equation ( 12 )$$

When the inverter 219 operates in the first non-linear region 445:

$$f 1 = ( \frac{\frac{\sqrt{3}}{3} {V}_{D C}}{cos ( \frac{π}{6} - α )} ) c o s ( θ ) , \qquad Equation ( 13 )$$

$$f 2 = ( \frac{\frac{\sqrt{3}}{3} {V}_{D C}}{cos ( \frac{π}{6} - θ )} ) cos ( θ ) , \qquad Equation ( 14 )$$

$$f 3 = ( \frac{\frac{\sqrt{3}}{3} {V}_{D C}}{cos ( \frac{π}{6} - α )} ) cos ( θ ) , \qquad Equation ( 15 )$$

$$and$$

$$f 4 = ( \frac{\frac{\sqrt{3}}{3} {V}_{D C}}{cos ( \frac{π}{2} - θ )} ) cos ( θ ) . \qquad Equation ( 16 )$$

When the inverter 219 is in the second non-linear region 447:

$$f 1 = \frac{2}{3} {V}_{DC} , \qquad Equation ( 17 )$$

$$f 2 = ( \frac{\frac{\sqrt{3}}{3} {V}_{DC}}{cos ( \frac{π}{6} - {θ}^{′} )} ) cos ( {θ}^{′} ) , \qquad Equation ( 18 )$$

where θ′=h (θ−α) and h is defined as shown in Equation (10),

$$f 3 = \frac{1}{3} {V}_{D C} , \qquad Equation ( 19 )$$

$$and$$

$$f 4 = ( \frac{\frac{\sqrt{3}}{3} {V}_{D C}}{cos ( \frac{π}{2} - {θ}^{′} )} ) cos ( {θ}^{′} ) . \qquad Equation ( 20 )$$

To prepare the first lookup table 285, the adjustment value (α) is set to a particular numerical value (710). The adjustment value (α) may be set to the particular numerical value randomly or intentionally. The voltage command (V*) is determined for the particular numerical value of (α) using Equation (12) and Equations (13) to (16) (720). The modulation index (M) is determined using Equation (3), with V* from (720) being used as the value of Vref (730). This modulation index (M) is associated with the particular numerical value used for (α). The modulation index (M) is stored in association with the particular numerical value used as (α) as an entry in the first lookup table 285 (740). If more entries are to be added to the first lookup table (745), the process 700A returns to (710) and repeats (710) to (740) until the lookup table 285 is complete (745). Any criterion may be used to determine if the first lookup table 285 is complete. For example, the number of entries for the first lookup table 285 may be a predetermined number of entries, and the first lookup table 285 is determined to be complete when that number of entries have been calculated and entered into the lookup table 285. If the lookup table 285 is complete (245), the process 700A outputs the lookup table 285 by, for example, storing the lookup table on the electronic storage 234.

The process 700B is an example of using the first lookup table 285. To use the first lookup table 285, the lookup table 285 is accessed (750), and a modulation index (M) value in the first non-linear region 445 is provided as the input to the first lookup table 285 (755). The adjustment value (α) that corresponds to that modulation index (M) is returned as the output (760). The process 700B may be invoked at (627) to obtain the adjustment value for the first non-linear region 445.

The second lookup table 286 that relates the adjustment value (α) to modulation index (M) in the second non-linear region 447 is also generated using the process 700A, except the voltage command (V*) is determined for the particular numerical value of (α) using Equation (12) and Equations (17) to (20). After the voltage command (V*) for the particular value of (α), the modulation index (M) is determined using Equation (3). The determined modulation index (M) is associated with the particular value of (α). By repeatedly varying (α) and determining the modulation index (M) associated with each value of (α), and storing value of (α) in association with its corresponding modulation index (M), entries for the second lookup table 286 are generated until the second lookup table 286 is complete.

The process 700B is used to obtain a value of (α) for a particular modulation index (M) in the second non-linear region 447.

FIG. 8 is a flowchart of a process 800 implemented by the command module 382 to generate the inverter gate command 351 using the outputs of the correction module 381.

Variables (d1, d2) are determined based on the voltage command (V*) and phase angle (θ*) output from the correction module 381 (810). The variables d1 and d2 are the calculated dwelling time ratios for each active voltage vector being used for voltage synthesis during one switching cycle in SVPWM. The sum of d1 and d2 (d1+d2) should be no greater than 1 for the inverter 219 to operate within the hexagon 439 that defines the limit of operation of the inverter 219. If the sum of d1 and d2 is greater than 1, a scaling adjustment is performed using the process 800.

The variables d1 and d2 are determined as follows:

$$d 1 = \frac{\sqrt{3} {V}^{*}}{{V}_{DC}} sin ( \frac{π}{3} - {θ}^{*} ) , \qquad Equation ( 21 )$$

$$d 2 = \frac{\sqrt{3} {V}^{*}}{{V}_{DC}} sin ( {θ}^{*} ) , \qquad Equation ( 22 )$$

where V* is the voltage command (V*) from the correction module 381, θ* is the phase angle from the correction module 381, and VDC is the voltage across the DC link 218. The variables are summed and compared to a threshold that has a value of 1 to ensure that the output voltage vector does not exceed the operating limit of the inverter. If the sum of d1 and d2 is greater than the threshold, the values of the variables d1, d2 a scaling adjustment (820) is performed as follows:

$$d {1}^{′} = \frac{{d}_{1}}{{d}_{1} + {d}_{2}} , \qquad Equation ( 23 )$$

$$d {2}^{′} = \frac{{d}_{2}}{{d}_{1} + {d}_{2}} . \qquad Equation ( 24 )$$

The value of d1 is set to d1′, and the value of d2 is set to d2′.

If the sum of d1 and d2 does not exceed the threshold, the values of variables d1 and d2 are not adjusted.

The inverter gate command 351 is determined based on the variables d1 and d2 and the sector(S) of the voltage command (V*) (825). The inverter gate command 351 defines a switching pattern for each phase of the inverter 219 (CMP1, CMP2, CMP3). One of Equations (25) to (31) is used to determine the inverter gate command 351, with the appropriate Equation being selected based on the sector(S) of the voltage command (V*).

For a voltage command (V*) with S=1, Equation (25) determines the inverter gate command 351 as follows: CMP1: (1-d1−d2)*TB, CMP2: (1+d1−d2)*TB, CMP3: (1+d1+d2)*TB.

For a voltage command (V*) with S=2, Equation (26) determines the inverter gate command 351 as follows: CMP1: (1+d2−d1)*TB, CMP2: (1-d1−d2)*TB, CMP3: (1+d1+d2)*TB.

For a voltage command (V*) with S=3, Equation (27) determines the inverter gate command 351 as follows: CMP1: (1+d1+d2)*TB, CMP2: (1-d1−d2)*TB, CMP3: (1+d1−d2)*TB.

For a voltage command (V*) with S=4, Equation (28) determines the inverter gate command 351 as follows: CMP1: (1+d1+d2)*TB, CMP2: (1+d2−d1)*TB, CMP3: (1-d1−d2)*TB.

For a voltage command (V*) with S=5, Equation (29) determines the inverter gate command 351 as follows: CMP1: (1+d1−d2)*TB, CMP2: (1+d1+d2)*TB, CMP3: (1-d1−d2)*TB.

For a voltage command (V*) with S=6, Equation (30) determines the inverter gate command 351 as follows: CMP1: (1-d1−d2)*TB, CMP2: (1+d1+d2)*TB, CMP3: (1+d2−d1)*TB.

If the sector(S) is unknown, Equation (31) determines the inverter gate command as follows: CMP1=CMP2=CMP3=0*TB=0.

In Equations (25) to (31), TB is a value that is equal to the timer base period divided by two. The timer base period is the timer counter value set for a specific switching frequency of the switches S1 to S6.

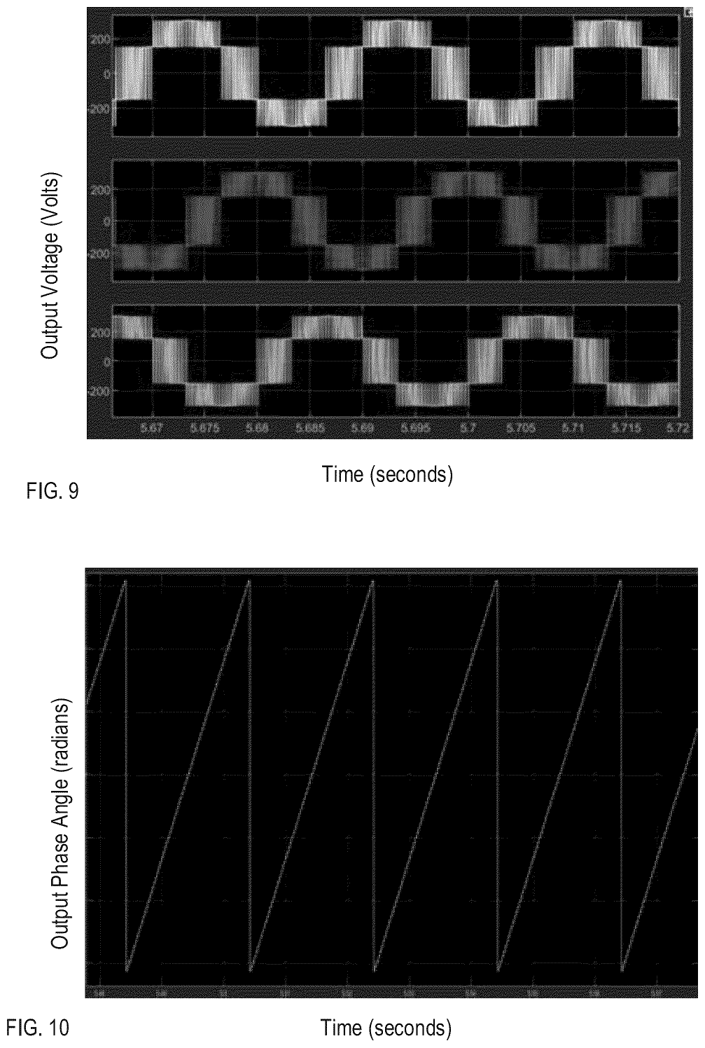

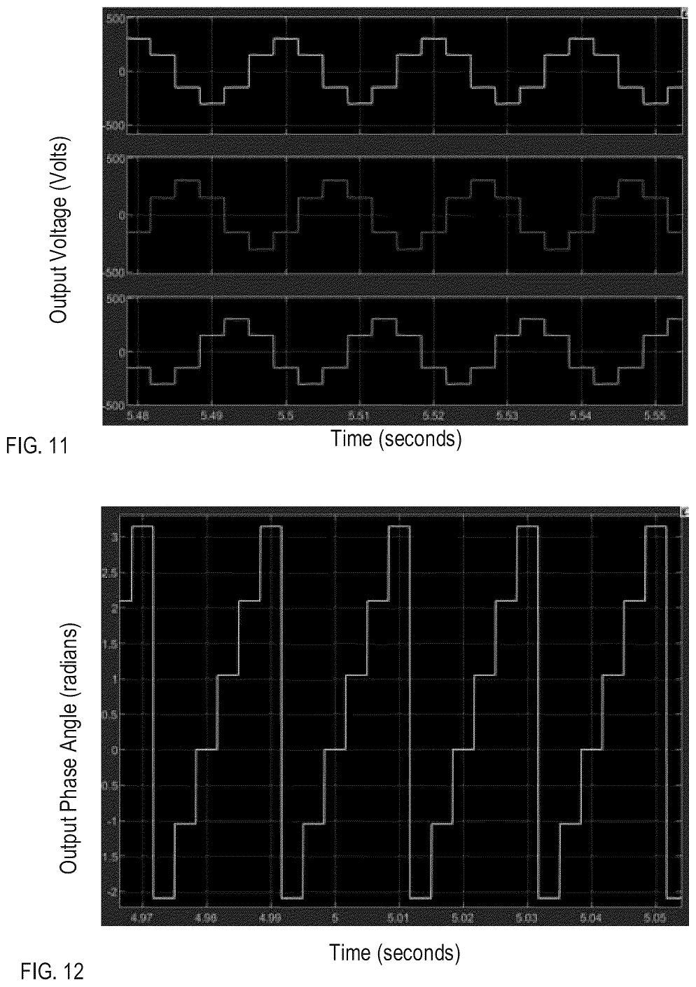

FIGS. 9 and 10 show data from a simulation of a system that uses a traditional SVPWM technique without the voltage boost module 380. FIGS. 11 and 12 show data from a simulation of the same system when using the voltage boost module 380. The system simulated was a power converter with a structure similar to the system shown in FIG. 2. The input voltage was 342V at 50 Hz, the AC inductors of 700 microHenries (μH) were in series with the rectifier, and the load was a motor having a torque of 86 newton-meters (Nm) and a modulation index (M) of 1. Thus, the inverter was not operating in the linear operating region in the simulation.

FIG. 9 shows the line-line output voltage (in volts) of each phase as a function of time, which was about 338 V at most (thus, less than the input voltage). Moreover, the output voltage (FIG. 9) is highly distorted. FIG. 10 shows the output reference phase angle (in radians) as a function of time. FIG. 9 and FIG. 10 have the same time axis and show the same time period. The voltage boost module 380 was not used in the simulation that produced the data shown in FIGS. 9 and 10.

FIG. 11 shows the three-phase voltage output as a function of time when the voltage boost module 380 is used. FIG. 12 shows the output reference phase angle as a function of time when the boost module 380 is used. FIG. 11 and FIG. 12 have the same time axis and show the same time period. As shown in FIG. 11, the peak line-line voltage output with the boost module 380 was about 353V, which is higher than the input voltage (342V in this example). Thus, the voltage boost module 380 was able to increase the output voltage such that the system provided sufficient output voltage even at the modulation index (M) of 1 (where the inverter is not in the linear region). Moreover, although the output voltage waveform (FIG. 11) is not purely sinusoidal, the output voltage has less distortion than the output waveform produced without the voltage boost module 380 and has been maximized in six-step operation without PWM switching events.

These and other implementations are within the scope of the claims.

What is claimed is:

1. A power converter comprising:
an energy storage apparatus;
an inverter electrically coupled to the energy storage apparatus; and
a voltage boost system configured to:
determine a modulation index based on a DC voltage of the energy storage apparatus and a target output voltage of the inverter; and
determine whether the target output voltage is in a voltage boost region based on the modulation index;
if the target output voltage is in the voltage boost region: determine an adjustment value based on the modulation index; and adjust one or more of the target output voltage and an associated output voltage phase angle based on the adjustment value.

2. The power converter of claim 1, wherein the voltage boost system is configured to:
determine an inverter gate command based on the target output voltage and the associated target output phase angle; and
provide the inverter gate command to the inverter.

3. The power converter of claim 1, wherein, if the target output voltage is in the voltage boost region, the voltage boost system is configured to determine whether the target output voltage is in one of a first voltage boost region and a second voltage boost region.

4. The power converter of claim 3, wherein,
if the target output voltage is in the first voltage boost region, the voltage boost system is configured to adjust the target output voltage based on the adjustment value; and
if the target output voltage is in the second voltage boost region, the voltage boost system is configured to adjust the associated target output voltage phase angle based on a second adjustment value.

5. The power converter of claim 1, wherein the adjustment value comprises an adjustment angle that is a function of the modulation index.

6. The power converter of claim 5, wherein the voltage boost system is configured to determine the adjustment value from a pre-determined look-up table.

7. The power converter of claim 1, further comprising a rectifier electrically connected to the energy storage apparatus.

8. The power converter of claim 7, further comprising a filter system electrically connected to the energy storage, the filter system configured to electrically connect to an alternating current (AC) power source, and wherein
the voltage boost system is configured to determine an inverter gate command based on the target output voltage and the associated target output phase angle; and
provide the inverter gate command to the inverter to control the inverter to produce the target output voltage at the target output voltage phase angle, and the peak voltage of the target output voltage is the same or greater than the peak voltage of the AC power source.

9. A control system for an inverter, the control system comprising:
a boost module configured to:
access a target output voltage and target output phase angle of the inverter;
determine a modulation index based on a DC bus voltage of an inverter and the target output voltage of the inverter;
determine whether the target output voltage is in a linear region of the inverter or a voltage boost region of the inverter based on the modulation index;
if the target output voltage is in the voltage boost region: determine an adjustment value based on the modulation index; and adjust one or more of the target output voltage and the target output voltage phase angle based on the adjustment value; and
if the target output voltage is in the linear region of the inverter, the boost module is configured to not adjust the target output voltage and the target output phase angle; and
a command module configured to:
determine an inverter command based on the target output voltage and the target output voltage phase angle; and
control the inverter based on the inverter command.

10. A method comprising:
determining a modulation index based on a measured DC bus voltage of an inverter and a target output voltage of the inverter;
determining whether a target output voltage of an inverter is in a space vector pulse width modulation (SVPWM) linear region based on the modulation index;
if the target output voltage of the inverter is outside of the linear region:
determining an angle adjustment value based on the modulation index; and
adjusting one of the target output voltage and a target output phase angle based on the angle adjustment value; and
if the target output voltage of the inverter is in the linear region, not adjusting the target output voltage or the target output phase angle.

11. The method of claim 10, wherein determining the angle adjustment value based on the modulation index comprises determining the angle adjustment value from a lookup table that relates the angle adjustment value to the modulation index.

12. The method of claim 11, further comprising: generating the lookup table by varying the angle adjustment value for a plurality of different values of the target output phase angle.

13. The method of claim 10, further comprising:
determining an inverter command based on the target output voltage and the target output voltage phase angle; and
controlling the inverter based on the inverter command.

14. The method of claim 13, wherein controlling the inverter based on the inverter command causes the inverter to output the target output voltage, and the target output voltage has a peak voltage that is the same as or greater than a peak voltage of an AC input.
